(19) United States
(12) Patent Application Publication
(10) Pub. No.: US 2008/0017170 A1
(43) Pub. Date: Jan. 24, 2008

(54) Fuel supply system for DME engine

(76) Inventors: Takahiro Moroi, Kariya-shi (JP); Shigeru Suzuki, Kariya-shi (JP); Masaki Ota, Kariya-shi (JP)

Correspondence Address: MORGAN & FINNEGAN, L.L.P., 3 World Financial Center, New York, NY, 10281-2101, US

(21) Appl. No.: 11/827,636

(22) Filed: Jul. 11, 2007

(30) Foreign Application Priority Data
Jul. 20, 2006 (JP) P2006-198252
Jan. 10, 2007 (JP) P2007-002471

(51) Int. Cl. F02M 61/16

(52) U.S. Cl. 123/456; 123/467

(57) ABSTRACT

A feed pump of a fuel supply system for a DME engine rotates in a normal direction to supply DME fuel in a fuel tank to a high-pressure supply pump through a low-pressure fuel supply passage. The high-pressure supply pump pressurizes the DME fuel and discharges the DME fuel therefrom. The discharged DME fuel is distributed by a high-pressure fuel supply passage and injected by a fuel injector. A first fuel recovery passage connects the high-pressure fuel supply passage to the low-pressure fuel supply passage. When the engine is operated, a first solenoid valve closes the first fuel recovery passage. When the engine is stopped, the first solenoid valve opens the first fuel recovery passage and the feed pump rotates in a reverse direction, thereby the DME fuel in the low-pressure fuel supply passage and in the high-pressure fuel supply passage is recovered into the fuel tank.

### BACKGROUND OF THE INVENTION

The present invention relates to a fuel supply system for a DME engine which uses DME (dimethylether) as fuel for an engine, and which recovers fuel when an engine is stopped.

DME is a clean energy which does not have serious influence on environment, and in recent years it has been attracting attention as a fuel in the next-generation. Especially DME has high cetane number and is oxygenated fuel, thereby emissions of black smoke is low when the DME fuel is combusted. Further, by exhaust gas recirculation (EGR), DME reduces the emission of NOx (nitrogen oxides) and particulate matter (PM). Thus, DME is expected to be utilized practically as an alternative fuel for light oil in a diesel engine.

DME has very low boiling point (minus 25 degrees centigrade), and easily evaporates. When the engine is stopped, highly-pressurized DME which is remained in a fuel supply passage of a DME fuel supply system is evaporated by heat from the engine and its exhaust system. It is difficult to prevent the evaporated DME in high pressure state from leaking out. After the engine is stopped, the evaporated DME leaks from a nozzle of a fuel injector and remains in a combustion chamber. When the engine is restarted, abnormal combustion may be happened and the engine may be damaged.

Japanese Patent Application Publication No. 2003-56409 discloses a DME fuel supply system provided with a purge system to prevent such abnormal combustion. DME fuel, which is remained in a fuel supply passage when an engine is stopped, is recovered into a purge tank from a common rail by a purge control valve. Then the DME fuel is applied to compression and reliquefaction in a reliquefaction compressor, and is returned to a fuel tank.

In the DME engine fuel supply system described above, large space is required to install the purge tank and the reliquefaction compressor, and such DME engine fuel supply system may not be provided on a small-sized truck. Especially, diaphragm type compressor which is used as reliquefaction compressor is generally large. Further, because materials which are applied to improve lubrication have corrosive properties against resin materials, resin materials are not able to use for member of the compressor. That makes reduction in weight difficult. Further, to cool reliquefy the DME fuel pressurized in the reliquefaction compressor reliably, a heat exchanger is required. Thus the system needs further larger space to install. For prevention from mixing lubricant oil into DME fuel, reliquefaction compressor needs to be non-lubrication type. Non-lubrication type compressor tends to be easily locked. Because high compression rate is required for reliquefaction, high energy is required for driving reliquefaction compressor and that may cause energy loss in the whole system.

The present invention which is made in view of the above problems is directed to a fuel supply system for a DME engine which prevents DME fuel from leaking into a combustion chamber, and which is installed in vehicles, without providing with a purge tank and a reliquefaction compressor.

### SUMMARY OF THE INVENTION

An aspect in accordance with the present invention provides a fuel supply system using DME as fuel for a DME engine which comprises a fuel tank, a feed pump, a low-pressure fuel supply passage, a high-pressure supply pump, a high-pressure fuel supply passage, a fuel injector, a first fuel recovery passage, and a first solenoid valve. The fuel tank stores DME fuel as fuel for the DME engine. The feed pump rotates in a normal direction to supply the DME fuel in the fuel tank to the low-pressure fuel supply passage, and rotates in a reverse direction to recover the DME fuel to the fuel tank. The high-pressure supply pump is connected to the low-pressure fuel supply passage and the DME fuel is supplied to the high-pressure supply pump from the feed pump. The DME fuel is pressurized in the high-pressure supply pump and discharged therefrom. The high-pressure fuel supply passage distributes the DME fuel discharged from the high-pressure supply pump. The fuel injector injects the DME fuel distributed from the high-pressure fuel supply passage. The first fuel recovery passage connects the high-pressure fuel supply passage to the low-pressure fuel supply passage. The first solenoid valve opens and closes the first fuel recovery passage. When the engine is operated, the first solenoid valve closes the first fuel recovery passage. When the engine is stopped, the first solenoid valve opens the first fuel recovery passage and the feed pump rotates in a reverse direction, thereby the DME fuel in the low-pressure fuel supply passage and in the high-pressure fuel supply passage is recovered into the fuel tank.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a block diagram of a fuel supply system for a DME engine of a first preferred embodiment according to the present invention;

FIG. 2 is a block diagram of a fuel supply system for a DME engine of a second preferred embodiment according to the present invention;

FIG. 3 is a block diagram of a fuel supply system for a DME engine of a third preferred embodiment according to the present invention; and

FIG. 4 is a block diagram of a fuel supply system for a DME engine of a fourth preferred embodiment according to the present invention.

### DETAILED DESCRIPTION OF THE PREFERRED EMBODIMENTS

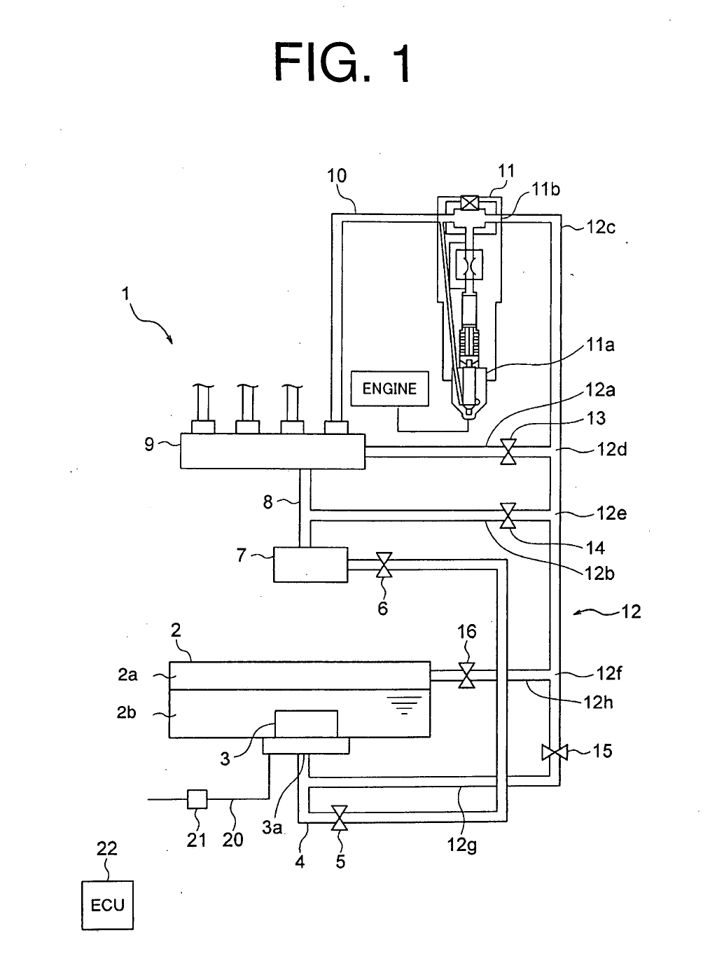

The following will describe a fuel supply system for a DME engine of a first preferred embodiment according to the present invention with reference to FIG. 1. Referring to FIG. 1, a fuel supply system 1 for a DME engine has a fuel tank 2 which stores DME as fuel. In the fuel tank 2, the DME fuel in gas phase is indicated as a gas phase part 2a, and the DME fuel in liquid phase is indicated as a liquid phase part 2b. The fuel tank 2 includes a feed pump 3 therein. The feed pump 3 is connected to a low-pressure fuel supply passage 4. An excess flow stop valve 5 is located in the low-pressure fuel supply passage 4. The excess flow stop valve 5 prevents the DME fuel from flowing out to the outside of the system when breakage of the fuel supply passages occurs.

The feed pump 3 is an electric type gear pump in which a motor is installed. The feed pump 3 is connected to a power energy, which is not shown, by a motor power energy cable 20. The cable 20 has a switch 21 to shift connection of U-phase, V-phase, and W-phase. The feed pump 3 rotates in a normal direction, or rotates in a reverse direction by switching the switch 21. The switch 21 is electrically connected to an electronic computer unit (hereinafter referred to ECU) 22. The switch 21 is switched by the ECU 22, thereby the feed pump 3 rotates in the normal direction when the engine is operated, and rotates in the reverse direction when the engine is stopped.

A high-pressure supply pump 7 as a high-pressure pump is connected to the feed pump 3 at a discharge port 3a through a low-pressure fuel supply passage 4. The low-pressure fuel supply passage 4 is located at the upstream side of the high-pressure supply pump 7. A solenoid valve 6 as a third solenoid valve is located in the low-pressure fuel supply passage 4 to open and close the low-pressure fuel supply passage 4. The third solenoid valve 6 is electrically connected to the ECU 22. The ECU 22 controls the operation of the third solenoid valve 6, and the third solenoid valve 6 is opened when the engine is operated, and is closed when the engine is stopped. The high-pressure supply pump 7 is operated by the engine which is not shown, and the drive power of the high-pressure supply pump 7 is transmitted from the engine. The DME fuel is supplied from the low-pressure fuel supply passage 4 to the high-pressure supply pump 7, and is pressurized and discharged from the pump 7.

A common rail 9 is connected to the high-pressure supply pump 7 by a first high-pressure supply passage 8. The common rail 9 is connected to a fuel injector 11 through a second high-pressure fuel supply passage 10. Each cylinder of the engine has a corresponding fuel injector 11. The fuel injector 11 has a nozzle 11a and a leakage port 11b. The excess DME fuel is discharged through the leakage port 11b to the outside of the system 1. The DME fuel with high pressure is distributed from the common rail 9, and is injected into a combustion chamber (not shown) through the nozzle 11a. A high-pressure fuel supply passage is constituted by the first high-pressure fuel supply passage 8 located downstream side of the high-pressure supply pump 7, the common rail 9, and the second high-pressure fuel supply passage 10.

The fuel supply system 1 includes a fuel recovery passage 12. The fuel recovery passage 12 includes a confluence passage 12g. One end of the confluence passage 12g is connected to the upstream side of the excess flow stop valve 5 of the low-pressure fuel supply passage 4. The other end of the confluence passage 12g is connected to a first branch passage 12a and a third branch passage 12c at a branch point 12d. The confluence passage 12g is connected to a second branch passage 12b at a branch point 12e. A first fuel recovery passage is constituted by the confluence passage 12g, the first branch passage 12a, and the second branch passage 12b. The branch passages 12a, 12b, 12c merge into the confluence passage 12g of the fuel recovery passage 12, and the confluence passage 12g has a solenoid valve 15 to open and close the confluence passage 12g. The first branch passage 12a is connected to the common rail 9, and has a solenoid valve 13 to open and close the branch passage 12a. The second branch passage 12b is connected to the first high-pressure fuel supply passage 8 and has a solenoid valve 14 to open and close the second branch passage 12b. The solenoid valves 13, 14, 15 are electrically connected to the ECU 22. The ECU 22 controls the operation of the solenoid valves 13, 14, 15, and the solenoid valves 13, 14, 15 are closed when the engine is operated, and the valves 13, 14, 15 are opened when the engine is stopped. The solenoid valves 13, 14, 15 function respectively as a first solenoid valve to open and close the first fuel recovery passage 12a, 12b, 12g.

The third branch passage 12c is connected to the leakage port 11b of the fuel injector 11. One end of a fourth branch passage 12h is connected to the fuel recovery passage 12 at a connection point 12f which is located between the branch point 12e and the first solenoid valve 15. The other end of the fourth branch passage 12h is connected to the gas phase part 2a in the fuel tank 2. The fourth branch passage 12h has a second solenoid valve 16 to open and close the fourth branch passage 12h. The second solenoid valve 16 is electrically connected to the ECU 22. The second solenoid valve 16 is opened when the engine is operated, and is closed when the engine is stopped. A second fuel recovery passage is constituted by the third branch passage 12c, part of the confluence passage 12g (between the branch point 12d and the connection point 12f, and the fourth branch passage 12h.

The following will describe operation of the fuel supply system for the DME engine of the first preferred embodiment. As shown in FIG. 1, the DME fuel is stored in the fuel tank 2 of the fuel supply system 1. When the engine is operated, the ECU 22 controls the switch 21, thereby the feed pump 3 rotates in a normal direction, and the DME fuel in the fuel tank 2 is supplied to the low-pressure fuel supply passage 4 through the discharge port 3a of the feed pump 3. The third solenoid valve 6 is controlled to be opened when the engine is operated, and the DME fuel is supplied to the high-pressure supply pump 7 through low-pressure fuel supply passage 4.

The DME fuel with low pressure, which is supplied from the low-pressure fuel supply passage 4, is pressurized in the high-pressure supply pump 7 and is discharged from the pump 7 to the first high-pressure fuel supply passage 8 to be supplied to the common rail 9. Then the DME fuel is distributed to each of the fuel injector 11 through the second high-pressure fuel supply passage 10. The fuel injector 11 injects the highly-pressurized DME fuel through the nozzle 11a to the combustion chamber. The DME fuel injected into the combustion chamber is applied compression ignition, and combusted, similar to a normal diesel engine.

While the DME fuel is supplied to the combustion chamber from the fuel tank 2, the DME fuel flows into the first branch passage 12a and the second branch passage 12b. The solenoid valves 13, 14 are closed when the engine is operated, thereby the DME fuel in the first high-pressure fuel supply passage 8 and the common rail 9 is prevented from flowing into the fuel tank 2 through the first branch passage 12a, the second branch passage 12b, and the confluence passage 12g. The second solenoid valve 16 is opened when the engine is operated, thereby the DME fuel discharged from the leakage port 11b of the fuel injector 11 is recovered into the fuel tank 2 through the third branch passage 12c, the confluence passage 12g, and the fourth branch passage 12h. The solenoid valve 15 is closed when the engine is operated, thereby the DME fuel discharged from the leakage port 11b of the fuel injector 11 is prevented from flowing into the low-pressure fuel supply passage 4.

When the engine is stopped, the injection of the DME fuel from the fuel injector 11 to the combustion chamber is stopped, and the flow of the DME fuel in the fuel supply system 1 is stopped. Thus, the DME fuel with high pressure is remained on the downstream side of the high-pressure supply pump 7, and the DME fuel with low pressure is remained on the upstream side of the pump 7. The DME fuel with high pressure is remained in the part of the first branch passage 12a which is nearer to the common rail 9 than the solenoid valve 13, and in the part of the second branch passage 12b which is nearer to the first high-pressure supply passage 8 than the solenoid valve 14.

The solenoid valves 13, 14 are opened when the engine is stopped. The first high-pressure fuel supply passage 8 and the common rail 9, and the confluence passage 12g communicate through the first branch passage 12a and the second branch passage 12b. When the engine is stopped, the solenoid valve 15 is opened, and the low-pressure fuel supply passage 4 is connected to the confluence passage 12g. When the engine is stopped, the ECU 22 shifts the switch 21 to rotate the feed pump 3 in a reverse direction. Thus, the DME fuel remained at the downstream side of the high-pressure supply pump 7 is sucked into the feed pump 3 through the first branch passage 12a or the second branch passage 12b, the confluence passage 12g, and the low-pressure supply passage 4, and is recovered into the fuel tank 2. The confluence passage 12g is connected to the low-pressure supply passage 4 at the upstream side of the excess flow stop valve 5, and the excess flow stop valve 5 does not interfere the recovery of the DME fuel into the fuel tank 2.

The DME fuel with low pressure is remained in the low-pressure fuel supply passage 4, and is also sucked into the feed pump 3. Thus, the DME fuel remained at the upstream side of the high-pressure supply pump 7 is recovered into the fuel tank 2. The third solenoid valve 6 is closed when the engine is stopped, and the DME fuel remained in the low-pressure fuel supply passage 4 does not flow to the downstream side of the high-pressure supply pump 7. The second solenoid valve 16 is closed when the engine is stopped, and the DME fuel in the fuel tank 2 does not flow into the confluence passage 12g through the fourth branch passage 12h. It is presumed that the recovered DME fuel in the fuel tank 2 is in the state which gas phase and liquid phase is mixed. The DME fuel in gas phase, which is recovered into the fuel tank 2, is cooled in the fuel tank 2 and tends to change into liquid phase, because the fuel tank 2 has more radiation effect than the low-pressure fuel supply passage 4, the first high-pressure fuel supply passage 8, and the second high-pressure fuel supply passage 10.

As described above, the upstream side and downstream side of the high-pressure supply pump 7 is connected through the confluence passage 12g, the first and second branch passages 12a, 12b (the first fuel recovery passage). The first fuel recovery passage includes solenoid valves 13, 14, 15 (the first solenoid valves) to open and close the first fuel recovery passage. When the engine is operated, the first solenoid valves are closed. When the engine is stopped, the first solenoid valves are opened and the feed pump 3 rotates in the reverse direction so as to recover the DME fuel remained in the first high-pressure fuel supply passage 8, the common rail 9, and the second high-pressure fuel supply passages 10 (high-pressure fuel supply passage), and the low-pressure fuel supply passage 4 into the fuel tank 2. Accordingly, the DME fuel remained in the high-pressure fuel supply passages and the low-pressure fuel supply passage 4 does not leak from the fuel injector 11 into the combustion chamber when the engine is stopped. Further, the fuel supply system of this embodiment is installable to vehicles, because the fuel supply system does not have a purge tank and a reliquefaction compressor.

The common rail 9 constitutes part of the high-pressure fuel supply passage. The common rail 9 is connected to the first branch passage 12a, and the DME fuel remained in the common rail 9 is recovered reliably. Further, one end of the confluence passage 12g is connected to the low-pressure fuel supply passage 4 at the upstream side of the excess flow stop valve 5 so that the DME fuel remained in the high-pressure fuel supply passages is recovered effectively into the fuel tank 2 when the engine is stopped, without the resistance of the excess flow stop valve 5. The fuel injector 11 is connected to the gas phase part 2a in the fuel tank 2 through the third branch passage 12c, the confluence passage 12g, and the fourth branch passage 12h (the second fuel recovery passage), and the second solenoid valve 16 is located in the fourth branch passage 12h to open and close the second fuel recovery passage. The second solenoid valve 16 is opened when the engine is operated. Accordingly, the excess DME fuel, which is discharged from the fuel injector 11 when the engine is operated, is recovered into the fuel tank 2. When the engine is stopped, the second solenoid valve 16 is closed, and the DME fuel in the fuel tank 2 does not flow into the confluence passage 12g through the fourth branch passage 12h.

Additionally, the third solenoid valve 6 is located in the low-pressure fuel supply passage 4. The third solenoid valve 6 is closed when the engine is stopped so that the DME fuel remained in the low-pressure fuel supply passage 4 does not flow to the downstream side of the high-pressure supply pump 7.

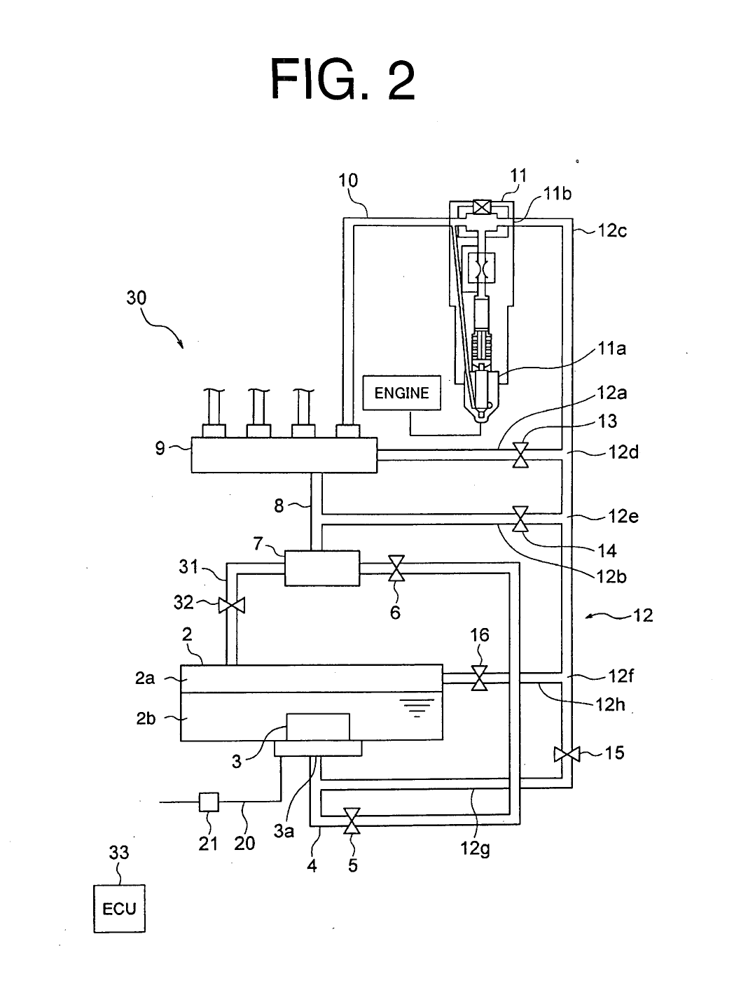

The following will describe a fuel supply system for a DME engine of a second preferred embodiment with reference to FIG. 2. The similar structures to the first embodiment are indicated by the same reference numbers, and the description for the identical components will not be reiterated. The second embodiment differs from the first embodiment in the structure that the gas phase part 2a of the fuel tank 2 is connected to the high-pressure side of high-pressure supply pump 7 through a solenoid valve.

FIG. 2 shows a fuel supply system 30 for a DME engine. The gas phase part 2a of the fuel tank 2 is connected to the high-pressure side of high-pressure supply pump 7 through a third fuel recovery passage 31. The third fuel recovery passage 31 includes a fourth solenoid valve 32 to open and close the third fuel recovery passage 31. The fourth solenoid valve 32 is electrically connected to an ECU 33. The fourth solenoid valve 32 is controlled to be closed when the engine is operated, and to be opened when the engine is stopped. The ECU 33 controls not only the operation of the fourth solenoid valve 32, but also the operation of the solenoid valves 6, 13, 14, 15, 16 and switch 21, similar to the ECU 22 in the first embodiment.

The gas phase part 2a of the fuel tank 2 is connected to the high-pressure side of the high-pressure supply pump 7. Thus, the fuel supply system 30 equalizes the pressure of the DME fuel which is remained in high-pressure state at the downstream side of the high-pressure supply pump 7, and the pressure in the fuel tank 2 (saturated vapor pressure). That is, the pressure of the DME fuel remained at the downstream side of the high-pressure supply pump 7 is decreased at an early stage, and the DME fuel does not easily leak from the fuel injector 11 into the combustion chamber.

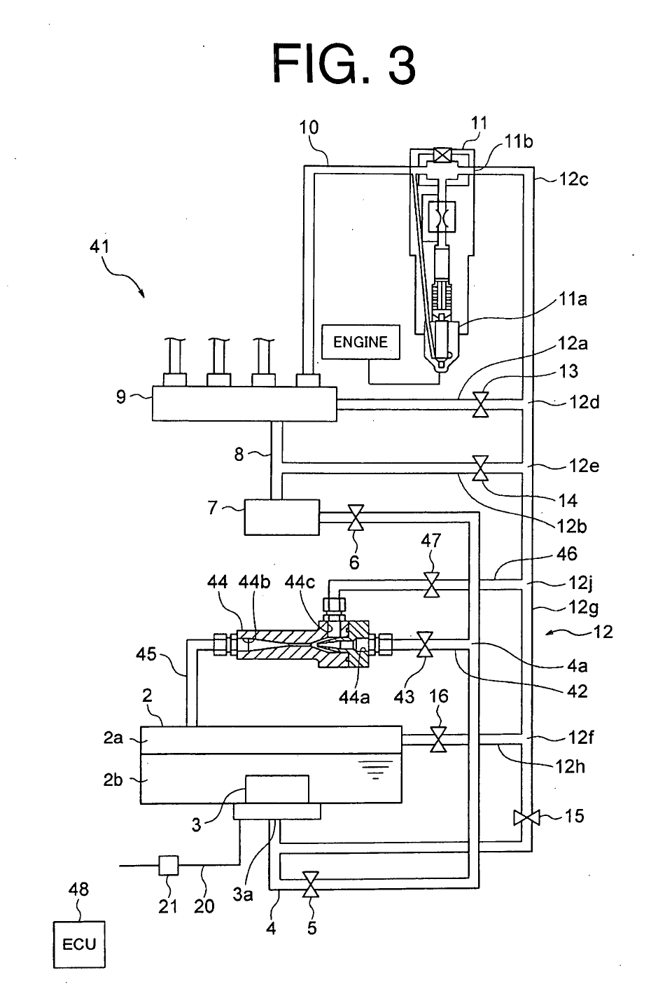

The following will describe a fuel supply system for a DME engine of a third preferred embodiment with reference to FIG. 3. The similar structures to the first embodiment are indicated by the same reference numbers, and the description for the identical components will not be reiterated. In addition to the first embodiment, the third preferred embodiment includes an ejector. When a predetermined time has passed after the stop of the engine, the DME fuel in liquid phase in the fuel tank 2 is used as flow to operate the ejector, and the ejector sucks the DME fuel in gas phase to recover the DME fuel into the fuel tank 2.

FIG. 3 shows a fuel supply system 41 for a DME engine, which includes an ejector 44. The ejector 44 includes a supply port 44a, a exhaust port 44b and a suction port 44c. The DME fuel is supplied to the ejector 44 through the supply port 44a, and the ejector 44 ejects the DME fuel inside the ejector 44 at high speed. Utilizing the pressure decrease at the suction port 44c at the ejection, the ejector 44 sucks the DME fuel in the fuel recovery passage 12 through the suction port 44c, and discharges both of the DME fuel supplied through the supply port 44a and the DME fuel sucked through the suction port 44c, through the exhaust port 44b to the fuel tank 2.

The supply port 44a of ejector 44 is connected to one end of a flow supply passage 42 for driving the ejector 44. The other end of the flow supply passage 42 is connected to the low-pressure supply passage 4 at a connection point 4a located between the excess flow stop valve 5 and the third solenoid valve 6. The flow supply passage 42 includes a sixth solenoid valve 43 to open and close the flow supply passage 42. The sixth solenoid valve 43 is electrically connected to an ECU 48. The ECU 48 controls the sixth solenoid valve 43. The sixth solenoid valve 43 is closed when the engine is operated. When the engine is stopped and until the predetermined time t has passed, the sixth solenoid valve 43 is closed, and when the predetermined time t has passed after the stop of the engine, the valve 43 is opened, by the control of the ECU 48. The exhaust port 44b of the ejector 44 is connected to one end of an exhaust passage 45. The other end of the exhaust passage 45 is connected to the gas phase part 2a of the fuel tank 2.

Accordingly, at the time when the predetermined time t has passed after the stop of the engine, the feed pump 3 is operated, and the DME fuel in the fuel tank 2 is supplied to the supply port 44a through the flow supply passage 42, and then the DME fuel is returned back to the fuel tank 2 through the exhaust port 44b and the exhaust passage 45.

The suction port 44c of the ejector 44 is connected to one end of a suction passage 46. The other end of the suction passage 46 is connected to the confluence passage 12g of the fuel recovery passage 12 at a connection point 12j which is located between the branch point 12e and the connection point 12f. The suction passage 46 includes a fifth solenoid valve 47 to open and close the suction passage 46. The fifth solenoid valve 47 is electrically connected to the ECU 48. The fifth solenoid valve 47 is controlled by the ECU 48. Similar to the sixth solenoid valve 43, the fifth solenoid valve 47 is closed when the engine is operated. The fifth solenoid valve 47 is also closed until a predetermined time t has passed after the stop of the engine. The fifth solenoid valve 47 is opened when the predetermined time t has passed after the stop of the engine.

The ECU 48 controls the operation of the sixth solenoid valve 43 and the fifth solenoid valve 47. When the engine is operated and until the predetermined time t has passed after the stop of the engine, the ECU 48 controls also the operation of the solenoid valves 6, 13, 14, 15, and 16, and the switch 21 similar to the ECU 22 in the first embodiment. When the predetermined time t has passed after the stop of the engine, the ECU 48 closes the solenoid valve 15, and shifts the switch 21 to rotate the feed pump 3 in a normal direction. Other structures are similar to the first embodiment. A table 1 indicates the operation of the feed pump 3, the third solenoid valve 6, the first solenoid valves 13, 14, 15, the second solenoid valve 16, the sixth solenoid valve 43, and the fifth solenoid valve 47.

TABLE 1
Operation of Solenoid Valves and Feed Pump According to the Third
Embodiment

| | | when engine is | when engine is |
|---|---|---|---|
| | | stopped (before | stopped (after |
| | | predetermined | predetermined |
| | when engine is | time t has passed) | time t has passed) |
| | operated | recovery of DME | recovery of DME |
| | — | in liquid phase | in gas phase |
| third solenoid | ON (opened) | OFF (closed) | OFF (closed) |
| valve 6 | | | |
| solenoid valve 13 | OFF (closed) | ON (opened) | ON (opened) |
| solenoid valve 14 | OFF (closed) | ON (opened) | ON (opened) |
| solenoid valve 15 | OFF (closed) | ON (opened) | OFF (closed) |
| second solenoid | ON (opened) | OFF (closed) | OFF (closed) |
| valve 16 | | | |
| fifth solenoid | OFF (closed) | OFF (closed) | ON (opened) |
| valve 47 | | | |
| sixth solenoid | OFF (closed) | OFF (closed) | ON (opened) |
| valve 43 | | | |
| feed pump 3 | normal rotation | reverse rotation | normal rotation |

The operation of the fuel supply system 41 for the DME engine of the third preferred embodiment with reference to FIG. 3 and the table 1. When the engine is operated, the feed pump 3 rotates in the normal direction, and the DME fuel in the fuel tank 2 is supplied to the high-pressure supply pump 7 through the low-pressure fuel supply passage 4. The sixth solenoid valve 43 and the fifth solenoid valve 47 are closed as indicated in the table 1, and the DME fuel in the low-pressure supply passage 4 does not flow into the ejector 44. When the engine is stopped, the feed pump 3 rotates in the reverse direction, to suck the DME fuel remained in the low-pressure fuel supply passage 4 and at the downstream side of the high-pressure fuel supply passage 7 and then the DME fuel is recovered into the fuel tank 2. The sixth solenoid valve 43 and the fifth solenoid valve 47 are closed as indicated in the table 1, and the DME fuel in the low-pressure fuel supply passage 4 and the confluence passage 12g of the fuel recovery passage 12 does not flow into the ejector 44. Thus, during the time when the engine is operated and during the time until the predetermined time t has passed after the stop of the engine, the fuel supply system 41 is operated similar to the fuel supply system 1 of the first embodiment. The predetermined time t is, for example, set as the time from the stop of the engine until the DME fuel in liquid phase is almost recovered by the reverse rotation of the feed pump 3 and the remained DME fuel is mainly in gas phase.

As indicated in the table 1, when the predetermined time t has passed after the stop of the engine, the sixth solenoid valve 43 and the fifth solenoid valve 47 are opened. As shown in FIG. 3, the low-pressure fuel supply passage 4 is connected to the supply port 44a of the ejector 44 through the flow supply passage 42, and the confluence passage 12g is connected to the suction port 44c of the ejector 44 through the suction passage 46. When the predetermined time t has passed after the stop of the engine, the solenoid valve 15 and the second solenoid valve 16 are closed. Thus, the communication between the confluence passage 12g and the low-pressure fuel supply passage 4 is disconnected by the solenoid valve 15, and the communication between the confluence passage 12g and the gas phase part 2a of the fuel tank 2 is disconnected by the second solenoid valve 16.

When the predetermined time t has passed after the stop of the engine, the feed pump 3 rotates in the normal direction, and discharges the DME fuel in liquid phase in the fuel tank 2 into the low-pressure fuel supply passage 4. Because the third solenoid valve 6 is closed when the engine is stopped, the DME fuel which is discharged to the low-pressure fuel supply passage 4 does not flow into the high-pressure supply pump 7, but flows through the connection point 4a and the flow supply passage 42 in this order to be supplied to the supply port 44a of the ejector 44. The DME fuel supplied to the supply port 44a of the ejector 44 is ejected inside the ejector 44 at high speed. Utilizing the pressure decrease at the suction port 44c at ejection, the ejector 44 sucks the DME fuel remained at the downstream side of the high-pressure supply pump 7 through the confluence passage 12g, the suction passage 46, and the suction port 44c. The second solenoid valve 16 is closed when the engine is stopped, and the DME fuel in gas phase in the fuel tank 2 does not flow into the confluence passage 12g through the fourth branch passage 12h. The ejector 44 mixes therein the DME fuel which is supplied through the supply port 44a and the DME fuel which is sucked through the suction port 44c, and the mixed DME fuel is discharged to the exhaust passage 45 through the exhaust port 44b, and is returned back to the fuel tank 2.

Thus, the DME fuel in the fuel tank 2 is supplied to the supply port 44a of the ejector 44. The DME fuel remained at the downstream side of the high-pressure supply pump 7 is sucked into the ejector 44 through the suction passage 46 and the suction port 44c. The DME fuel is recovered into the fuel tank 2 through the exhaust port 44b and the exhaust passage 45. When the predetermined time t has passed after the stop of the engine, the DME fuel in gas phase is remained at the downstream side of the high-pressure supply pump 7. The feed pump 3 rotates in the normal direction and discharges the DME fuel in liquid phase in the fuel tank 2. Thus, it is prevented that only the DME fuel in gas phase may circulate in the feed pump 3 and that non-lubrication state may occur. Accordingly durability of the feed pump 3 is improved, and the reliability of the fuel supply system 41 for the DME engine is improved. The flow supply passage 42 is connected to the flow-pressure fuel supply passage 4, and the flow supply passage 42 has the sixth solenoid valve 43 which is opened when the predetermined time t has passed after the stop of the engine. Thus, part of the low-pressure fuel supply passage 4 is utilized to supply the DME fuel to the ejector 44, and the piping of the fuel supply system 41 for the DME engine is simplified and the fuel supply system 41 is downsized.

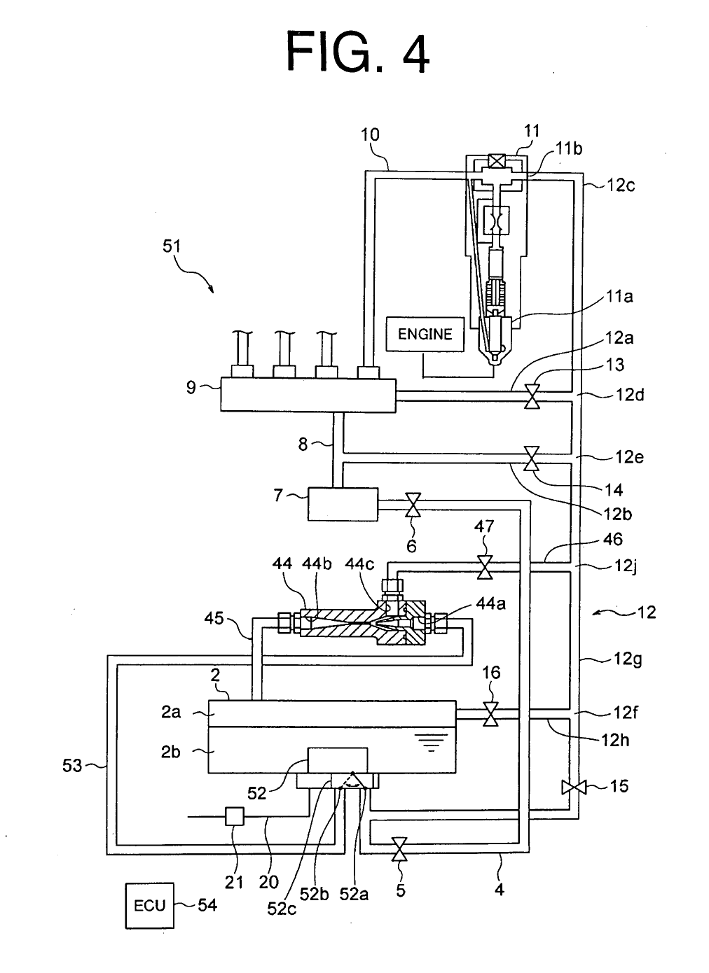

The following will describe a fuel supply system for a DME engine of a fourth preferred embodiment with reference to FIG. 4. The fourth embodiment differs from the third embodiment in the structure that a solenoid switch valve is integrated with the feed pump and that a flow supply passage connects the fuel tank 2 and the ejector 44 directly.

FIG. 4 shows a fuel supply system 51 for a DME engine. The fuel tank 2 of the fuel supply system 51 includes a feed pump 52 therein. The feed pump 52 has a discharge port 52a, 52b. The discharge port 52a is connected to the low-pressure fuel supply passage 4. The discharge port 52b is connected to one end of a flow supply passage 53. The other end of the flow supply passage 53 is connected to the supply port 44a of the ejector 44.

The feed pump 52 has a solenoid switching valve 52c. By shifting the solenoid switching valve 52c, a compression chamber (not shown) of the feed pump 52 is connected to either the discharge port 52a or the discharge port 52b. The solenoid switching valve 52c is electrically connected to an ECU 54 and is controlled to switch the connection between the compression chamber and the discharge ports 52a, 52b. The compression chamber is connected to the discharge port 52a when the engine is operated or until when the predetermined time t has passed after the stop of the engine The compression chamber is connected to the discharge port 52b after the predetermined time t has passed after the stop of the engine. The ECU 54 shifts the solenoid switching valve 52c and controls the operation of the solenoid valves 6, 13, 14, 15, 16, 47, and the shift of the switch 21, similar to the ECU 48 of the third embodiment. A table 2 indicates the operation of the third solenoid valve 6, the solenoid valves 13, 14, 15 and the second solenoid valve 16, and the fifth solenoid valve 47, the feed pump 52, and the solenoid switching valve 52c. Other structures are similar to the third embodiment.

TABLE 2
Operation of Solenoid Valves and Feed Pump According to the Fourth
Embodiment

| | | when engine is | when engine is |
|---|---|---|---|
| | | stopped (before | stopped (after |
| | | predetermined | predetermined |
| | | time t has passed) | time t has passed) |
| | when engine is | recovery of DME | recovery of DME |
| | operated | in liquid phase | in gas phase |
| third solenoid | ON (opened) | OFF (closed) | OFF (closed) |
| valve 6 | | | |
| solenoid valve 13 | OFF (closed) | ON (opened) | ON (opened) |
| solenoid valve 14 | OFF (closed) | ON (opened) | ON (opened) |
| solenoid valve 15 | OFF (closed) | ON (opened) | OFF (closed) |
| second solenoid | ON (opened) | OFF (closed) | OFF (closed) |
| valve 16 | | | |
| sixth solenoid | OFF (closed) | OFF (closed) | OFF (closed) |
| valve 43 | | | |
| feed pump 52 | normal rotation | reverse rotation | normal rotation |
| solenoid | discharge port | discharge port | discharge port |
| switching | 52a | 52a | 52b |
| valve 52c | | | |
| (communicated | | | |
| to) | | | |

The operation of the fuel supply system 51 for the DME engine will be described with reference to FIG. 4 and the table 2. As indicated in the table 2, when the engine is operated, the feed pump 52 rotates in the normal direction, and the compression chamber is connected to the discharge port 52a through the solenoid switching valve 52c. When the engine is stopped, the feed pump 52 rotates in the reverse direction, and the feed pump 52 is connected to the discharge port 52a through the solenoid switching valve 52c. Thus, until when the predetermined time t has passed after the stop of the engine, the fuel supply system 51 is operated similar to the fuel supply system 41 of the third embodiment. Accordingly, the DME fuel does not flow into the flow supply passage 53 which is connected to the discharge port 52b, and DME is not supplied to the supply port 44a of the ejector 44.

When the predetermined time t has passed after the stop of the engine, the feed pump 3 rotates in the normal direction, and the compression chamber of the feed pump 3 is connected to the discharge port 52b though the solenoid switching valve 52c. Thus, the DME fuel in the fuel tank 2 is discharged to the flow supply passage 53, and is supplied to the supply port 44a of the ejector 44. When the predetermined time t has passed after the stop of the engine, the fifth solenoid valve 47 is opened. Accordingly, by the flow of the DME fuel supplied to the ejector 44 through the flow supply passage 53, the DME fuel in gas phase, which is remained at the downstream side of the high-pressure supply pump 7, is sucked into the ejector 44 through the suction passage 46.

As described above, the discharge port 52a is connected to the low-pressure fuel supply passage 4, and the discharge port 52b is connected to the flow supply passage 53. The connection between the discharge ports 52a, 52b and the compression chamber is switched by the solenoid switching valve 52c of the feed pump 52. That is, when the engine is operated or until the predetermined time t has passed after the stop of the engine, the discharge port 52a is connected to the compression chamber of the feed pump 52, and after the predetermined time t has passed, the discharge port 52b is connected to the compression chamber of the feed pump 52. Thus, the fourth embodiment has the same effect as the third embodiment.

Therefore, the present examples and embodiments are to be considered as illustrative and not restrictive, and the invention is not to be limited to the details given herein but may be modified within the scope of the appended claims.

What is claimed is:

1. A fuel supply system using DME as fuel for a DME engine, comprising:
a fuel tank storing DME as fuel for the DME engine;
a feed pump rotating in a normal direction to supply the DME fuel from the fuel tank, the feed pump rotating in a reverse direction to recover the DME fuel to the fuel tank;
a low-pressure fuel supply passage connected to the feed pump;
a high-pressure supply pump connected to the low-pressure fuel supply passage, the high-pressure supply pump to which the DME fuel is supplied from the feed pump through the low-pressure supply passage pressurizing the DME fuel and discharging the DME fuel therefrom;
a high-pressure fuel supply passage distributing the DME fuel discharged from the high-pressure supply pump;
an fuel injector injecting the DME fuel distributed from the high-pressure fuel supply passage;
a first fuel recovery passage connecting the high-pressure fuel supply passage to the low-pressure fuel supply passage;
a first solenoid valve opening and closing the first fuel recovery passage, wherein when the engine is operated, the first solenoid valve closes the first fuel recovery passage, and wherein when the engine is stopped, the first solenoid valve opens the first fuel recovery passage and the feed pump rotates in the reverse direction, thereby the DME fuel in the low-pressure fuel supply passage and in the high-pressure fuel supply passage is recovered into the fuel tank.

2. The fuel supply system for the DME engine according to claim 1, wherein the high-pressure fuel supply passage includes a common rail, and wherein the first fuel recovery passage includes a first branch passage connected to the common rail.

3. The fuel supply system for the DME engine according to claim 1, wherein the low-pressure fuel supply passage includes an excess flow stop valve, and wherein the first fuel recovery passage is connected to the low-pressure fuel supply passage at the upstream side of the excess flow stop valve.

4. The fuel supply system for the DME engine according to claim 1, further comprising:
a second fuel recovery passage connecting the fuel injector to a gas phase part of the fuel tank;
a second solenoid valve opening and closing the second fuel recovery passage, wherein the second solenoid valve opens the second fuel recovery passage when the engine is operated, and wherein the second solenoid valve closes the second fuel recovery passage when the engine is stopped.

5. The fuel supply system for the DME engine according to claim 1, further comprising a third solenoid valve opening and closing the low-pressure fuel supply passage, wherein the third solenoid valve opens the low-pressure fuel supply passage when the engine is operated, and wherein the third solenoid valve closes the low-pressure fuel supply passage when the engine is stopped.

6. The fuel supply system for the DME engine according to claim 1, further comprising:
a third fuel recovery passage connecting the high-pressure side of the high-pressure supply pump and a gas phase part of the fuel tank; and
a fourth solenoid valve opening and closing the third fuel recovery passage, wherein the fourth solenoid valve closes the third fuel recovery passage when the engine is operated, and the fourth solenoid valve opens the third fuel recovery passage when the engine is stopped.

7. The fuel supply system for the DME engine according to claim 1, further comprising:
an ejector having a supply port, an exhaust port, and a suction port, the ejector sucking the DME fuel through the suction port by utilizing pressure decrease of the DME fuel flowing from the supply port to the exhaust port;
a flow supply passage supplying the DME fuel in the fuel tank to the supply port of the ejector by the feed pump;
a suction passage connecting the first fuel recovery passage and the suction port of the ejector;
a fifth solenoid valve opening and closing the suction passage; and
an exhaust passage connecting the exhaust port of the ejector to a gas phase part of the fuel tank, wherein when a predetermined time has passed after the stop of the engine, the fifth solenoid valve opens the suction passage, and the feed pump rotates in the normal direction to supply the DME fuel in the fuel tank to the supply port of the ejector through the flow supply passage, wherein the DME fuel in the high-pressure supply passage and the first fuel recovery passage is supplied to the ejector through the suction passage to recover the DME fuel into the fuel tank.

8. The fuel supply system for the DME engine according to claim 7, wherein the flow supply passage connects the low-pressure fuel supply passage and the supply port of the ejector, and wherein the sixth solenoid valve opens and closes the flow supply passage, wherein the sixth solenoid valve opens the flow supply passage when the predetermined time has passed after the stop of the engine.
